(19) United States
(12) Patent Application Publication
(10) Pub. No.: US 2012/0241445 A1
(43) Pub. Date: Sep. 27, 2012

(54) COOKING APPLIANCE EMPLOYING MICROWAVES

(75) Inventors: Sung Hun Shim, Seoul (KR); Jin Yul Hu, Seoul (KR); Hyun Wook Moon, Seoul (KR); Heung Sik Choi, Seoul (KR); Wan Soo Kim, Seoul (KR)

(73) Assignee: LG ELECTRONICS INC., Seoul (KR)

(21) Appl. No.: 13/393,424

(22) PCT Filed: Jun. 18, 2010
(86) PCT No.: PCT/KR2010/003981

§ 371 Date: May 22, 2012

(30) Foreign Application Priority Data
Sep. 1, 2009 (KR) 10-2009-0082005
Sep. 8, 2009 (KR) 10-2009-0084604

(51) Int. Cl. H05B 6/68; H05B 6/70

(52) U.S. Cl. 219/702; 219/746; 219/747

(57) ABSTRACT

The present invention relates to a cooking appliance employing microwaves. According to the present invention, a cooking appliance employing microwaves comprises: a microwave generator for generating and outputting microwaves, provided with an amplifier for performing frequency oscillation and amplification; and a feeder for outputting the outputted microwaves into a cavity. Accordingly, high power microwaves can be easily generated without a separate frequency oscillator.

### TECHNICAL FIELD

The present invention relates to a cooking appliance using microwaves, and more particularly, to a cooking appliance using microwaves that can generate a high output of microwaves.

### BACKGROUND ART

In general, after a cooking appliance using microwaves receives and seals food, when an operation button is pressed, a voltage is applied to a high voltage generator, a common use voltage applied to the high voltage generator is boosted, power is applied to a magnetron for generating microwaves, and microwaves generated by the magnetron are transferred to a cavity through a waveguide.

In this case, the cooking appliance using microwaves vibrates molecules constituting food 2450 million times per second by radiating microwaves generated in the magnetron to food, thereby heating food with a generated frictional heat.

The cooking appliance using such microwaves can easily control a temperature and is widely used at a general home due to various advantages such as saving of a cooking time and convenience of manipulation.

### DISCLOSURE

### Technical Problem

An aspect of the present invention is to provide a cooking appliance using microwaves that can simply generate a high output of microwaves without a separate frequency oscillator.

Another aspect of the present invention is to provide a cooking appliance using microwaves that can compensate phase deformation of microwaves that may occur in each amplification stage when using a plurality of amplification stages.

### Technical Solution

In an aspect, a cooking appliance using microwaves includes: a microwave generator including an amplifier for performing frequency oscillation and amplification and for generating and outputting microwaves; and a feeder for outputting the output microwaves to the inside of a cavity.

In another aspect, a cooking appliance using microwaves includes: a microwave generator for generating and outputting a plurality of microwaves; an RF switch for separating a transmission path of the microwaves; and a feeder for outputting microwaves output from the RF switch to the inside of a cavity.

In another aspect, a cooking appliance using microwaves includes: a plurality of amplification stages for amplifying a plurality of microwaves, respectively; a phase detection unit for detecting phase deformation of each microwave having the same frequency; and a phase compensation unit for compensating phase deformation of microwaves having a deformed phase when a phase of at least one of the plurality of microwaves is deformed.

### Advantageous Effects

According to the present invention, by using a microwaves generator having an amplifier for performing together frequency oscillation and amplification, a high output of microwaves can be simply generated without a separate frequency oscillator.

Further, by connecting a plurality of amplifiers in series, parallel, or a mixed method of series and parallel to an output terminal of the amplifier, a high output of microwaves can be stably generated.

An RF switch for separating a transmission path of microwaves is used, and thus by using a plurality of feeders, a heating efficiency within a cavity can be increased.

Further, by separating a transmission path of a scan segment and a heating segment at an entire cooking segment using an RF switch, the cooking appliance can be efficiently formed. Particularly, a transmission path according to a low output of scan segment and a transmission path according to a high output of heating segment can be differently formed.

Further, by calculating a heating efficiency using microwaves output to the inside of a cavity and reflected microwaves, a target within a cavity can be efficiently heated according to a heating efficiency.

Further, in order to secure a high output, when a cooking appliance using microwaves uses a plurality of amplification stages, phase deformation of microwaves that may be generated at each amplification stage can be compensated.

### DESCRIPTION OF DRAWINGS

FIG. 1 is a partial perspective view illustrating a cooking appliance using microwaves according to an exemplary embodiment of the present invention;

FIG. 2 is a cross-sectional view illustrating the cooking appliance of FIG. 1;

FIG. 3 is an example of a block diagram illustrating the cooking appliance of FIG. 1;

FIG. 4 is a graph illustrating a change of a frequency of a scan segment;

FIG. 5 is a block diagram illustrating an example of the inside of a microwave generator of FIG. 3;

FIG. 6 is a block diagram illustrating another example of the inside of a microwave generator of FIG. 3;

FIG. 7 is a block diagram illustrating another example of a cooking appliance according to an exemplary embodiment of the present invention;

FIG. 8 is a block diagram illustrating another example of a cooking appliance according to an exemplary embodiment of the present invention;

FIG. 9 is a block diagram illustrating another example of a cooking appliance according to an exemplary embodiment of the present invention.

FIG. 10 is another example of a block diagram illustrating the cooking appliance of FIG. 1;

FIG. 11 is a diagram illustrating a configuration of an amplification processor of FIG. 10;

FIGS. 12 and 13 are graphs illustrating various examples of added microwaves and microwaves amplified at each amplification stage of FIG. 11;

FIG. 14 is a graph illustrating microwaves in which a deformed phase is compensated according to FIG. 11; and

FIG. 15 is a block diagram illustrating another example of the inside of a microwave generator of FIG. 3.

### BEST MODE

Hereinafter, the present invention will be described in detail with reference to the drawings.

Terms ‘module’ or ‘unit’ used in the description are provided to easily describe a specification and do not have important meanings or functions. Therefore, the ‘module’ or ‘unit’ may be mixed and used.

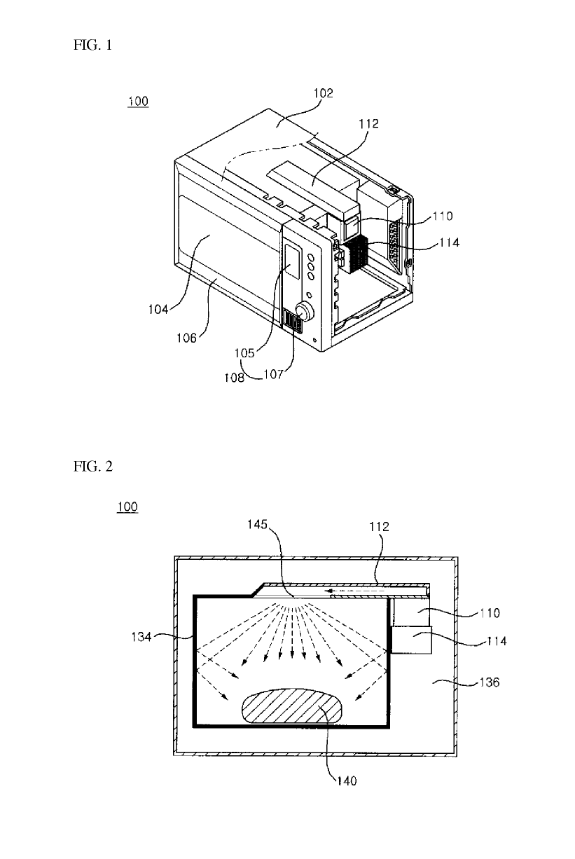

FIG. 1 is a partial perspective view illustrating a cooking appliance using microwaves according to an exemplary embodiment of the present invention, and FIG. 2 is a cross-sectional view illustrating the cooking appliance of FIG. 1.

Referring to the drawings, in a cooking appliance 100 using microwaves according to an exemplary embodiment of the present invention, a door 106 to which a cooking window 104 is attached is coupled to open and close to a front portion of a main body 102, and a manipulation panel 108 is coupled to one side portion of a front surface of the main body 102.

The door 106 opens and closes a cavity 134, and although not shown in the drawing, a filter (not shown) for shielding microwaves may be provided within the door 106.

The manufacturing panel 108 includes a manipulation unit 107 for manipulating operation of the cooking appliance and a display unit 105 for displaying operation of the cooking appliance.

At the inside of the main body 102, the cavity 134 for receiving a heating target 140, for example food and having reception space of a predetermined size in order to cook by microwaves is provided.

At an outside surface of the cavity 134, a microwave generator 110 for generating microwaves is installed, and at the output unit side of the microwave generator 110, a microwave transmitting unit 112 for guiding microwaves generated in the microwave generator 110 to the inside of the cavity 134 is disposed.

The microwave generator 110 may include a solid state power amplifier (SSPA) using a semiconductor. The SSPA has a merit of occupying space less than that of a magnetron.

For amplification, the SSPA may be formed with hybrid microwave integrated circuits (HMIC) separately having a passive element (a capacitor, an inductor, etc.) and an active element (a transistor, etc.) or monolithic microwave integrated circuits (MMIC) in which a passive element and an active element are formed as a single substrate.

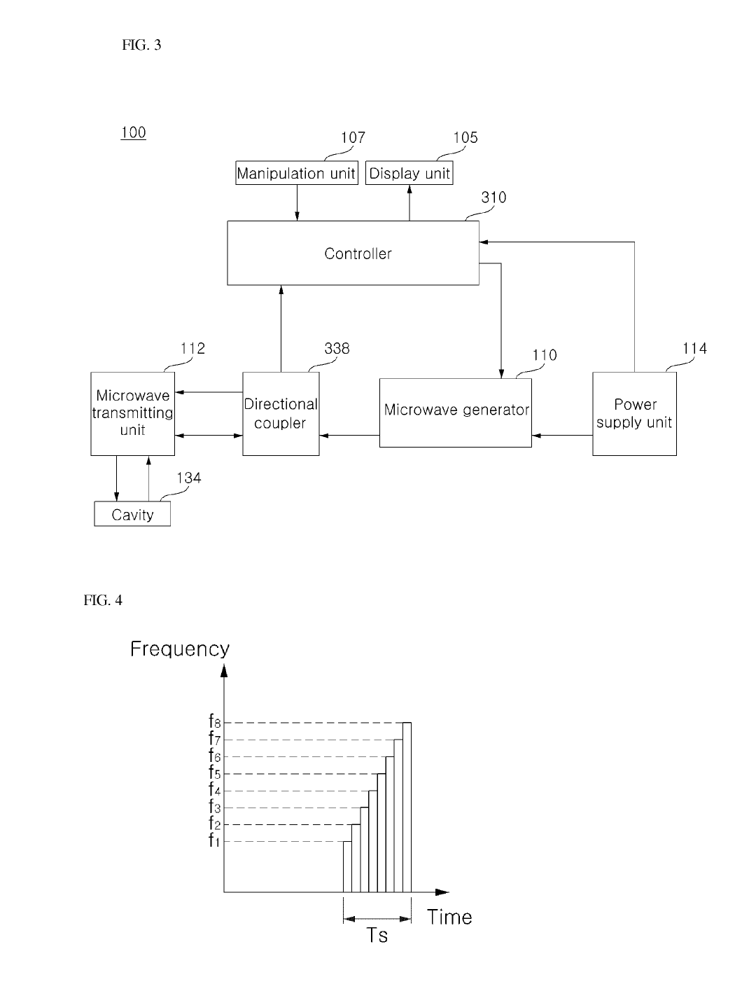

According to an exemplary embodiment of the present invention, the microwave generator 110 can generate and output a plurality of microwaves. A frequency range of such microwaves may be approximately 900 MHz to 2500 Hz. Particularly, a frequency range of such microwaves may be within a predetermined range from 915 MHz or within a predetermined range from 2450 MHz. A detailed description of the microwave generator 110 will be described hereinafter with reference to FIG. 3.

The microwave transmitting unit 112 transmits microwaves generated in and output from the microwave generator 110 to the cavity 134. The microwave transmitting unit 112 may include a waveguide, or a coaxial line.

In order to emit microwaves to the cavity 134, an end portion of the microwave transmitting unit 112 is connected to a feeder. In the drawing, as an example of the feeder, an opening 145 is illustrated, the feeder is not limited to the opening 145, and an antenna and an amplifier may be coupled to the feeder. The opening 145 may be formed in various forms such as a slot form. Through such a feeder, microwaves are emitted to the cavity 134.

In the drawing, one opening 145 is disposed at an upper part of the cavity 134, but the opening 145 may be disposed at a lower part or a side part of the cavity 134, and a plurality of openings may be disposed. Instead of the opening 145, the cavity 134 may be coupled through an antenna.

At a lower part of the microwave generator 110, a power supply unit 114 for supplying power to the microwave generator 110 is provided.

The power supply unit 114 may include a high voltage transformer for boosting a voltage of power input to the cooking appliance 100 to a high voltage and for supplying the power to the microwave generator 110, or an inverter for supplying a high output voltage of about 3500V or more generated as at least one switch element performs a switching operation to the microwave generator 110.

At the periphery of the microwave generator 110, a cooling fan (not shown) for cooling the microwave generator 110 may be installed.

Although not shown in the drawing, at the inside of the cavity 134, a turntable (not shown) for rotating the heating target 140 may be installed, and at the inside of the cavity 134, a stirrer fan (not shown) for distributing microwaves may be formed, and a cover (not shown) for preventing damage of the stirrer fan (not shown) may be installed. Such a stirrer fan (not shown) may be a kind of the antenna.

When a user opens the door 106 and puts the heating target 140 into the cavity 134, and closes the door 106, the cooking appliance 100 using the microwaves operates when the user presses a cooking selection button (not shown) and a start button (not shown) by manipulating the manipulation panel 108, particularly, the manipulation unit 107.

That is, the power supply unit 114 within the cooking appliance 100 boosts a voltage of an input AC power source to a DC power source of a high voltage and supplies the DC power to the microwave generator 110, the microwave generator 110 generates and outputs corresponding microwaves, and the microwave transmitting unit 112 transmits the generated microwaves and emits the generated microwaves to the cavity 134. Accordingly, the heating target 140, for example, a cooking target within the cavity 134 is heated. General operations of the cooking appliance 100 may be performed by a controller (not shown). A description of the controller (not shown) will be described with reference to the drawings.

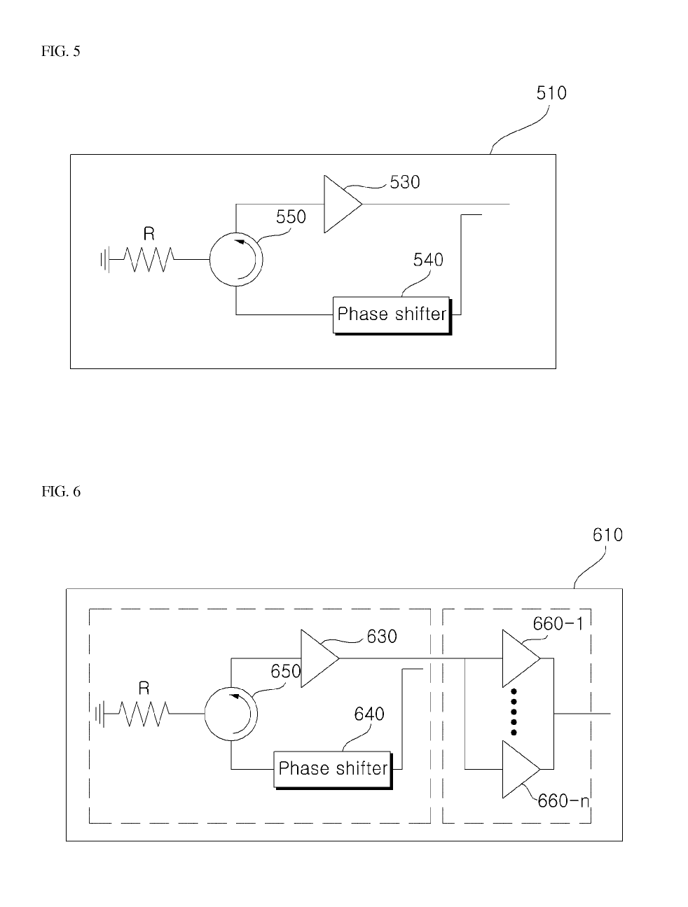

FIG. 3 is an example of a block diagram illustrating the cooking appliance of FIG. 1, and FIG. 4 is a graph illustrating a change of a frequency of a scan segment.

Referring to the drawings, the cooking appliance 100 according to an exemplary embodiment of the present invention includes a microwave generator 110. Further, the cooking appliance 100 may further include a controller 310 and a microwave transmitting unit 112. Further, the cooking appliance 100 may further include a directional coupler 338 and a power supply unit 114.

The microwave generator 110 includes an amplifier (not shown). The amplifier (not shown) performs frequency oscillation and amplification operation. The amplifier (not shown) according to an exemplary embodiment of the present invention voluntarily performs frequency oscillation and amplifies and outputs the frequency. Further, the amplifier (not shown) performs frequency oscillation and amplification operation and outputs a plurality of microwaves having different frequencies. Such a plurality of microwaves may be sequentially output.

As described above, the amplifier (not shown) may be a solid state power amplifier (SSPA) using a semiconductor element and may be provided in monolithic microwave integrated circuits (MMIC) using a single substrate. Thereby, the amplifier (not shown) can be easily controlled by the controller 310 and can integrate an element with a small size.

The amplifier (not shown) will be described later with reference to FIG. 5.

The directional coupler (DC) 338 transfers microwaves amplified in and output from the microwave generator 110, particularly, the amplifier (not shown) to the microwave transmitting unit 112. Microwaves transmitted from the microwave transmitting unit 112 and output from the feeder heat a target within the cavity 134. As described above, as the feeder, the opening 145 is illustrated, or an antenna or an amplifier may be used.

Microwaves reflected instead of not being absorbed into the subject may be input again to the directional coupler 338 through the feeder and the microwave transmitting unit 112. The directional coupler 338 transfers the reflected microwaves to the controller 310.

The cooking appliance 100 may further include a DC converter (not shown) disposed between the directional coupler 338 and the controller 310 and for converting the reflected microwaves to a control signal. Here, the DC converter (not shown) may be formed as a diode element.

The cooking appliance 100 may further include an isolation unit (not shown) disposed between the microwave generator 110 and the directional coupler 338 and for passing microwaves and blocking microwaves reflected from the cavity 134 when transferring microwaves amplified in the amplifier (not shown) to the cavity 134. Here, the isolation unit (not shown) may be formed as an isolator.

The amplifier (not shown) and the directional coupler 338 within the microwave generator 110 may be formed as one module. That is, the amplifier (not shown) and the directional coupler 338 may be disposed on one substrate to be formed as one module. The microwave generator 110 may be easily controlled by the controller 310 by integration of such an element.

As described later, the microwave generator 110 for generating a plurality of microwaves calculates a heating efficiency, varies a heating time according to the efficiency, and uniformly heats the target.

The controller 310 controls general operations of the cooking appliance. When an operation signal of the cooking appliance is input through the manipulation unit 107, the controller 310 controls the microwave generator 110 to sequentially output microwaves of a wide band frequency range.

For this reason, the controller 310 controls to output a phase control signal to a phase shifter (not shown) within the microwave generator 110. According to a phase control signal, the phase shifter (not shown) varies a phase of microwaves output from an amplifier (not shown), enables to supply the microwaves to the amplifier by feeding back again the microwaves, thereby enabling to output a plurality of microwaves of various frequencies. Operation of the amplifier (not shown) is performed hereinafter with reference to FIG. 5.

Further, the controller 310 compares power of output microwaves and reference power and constantly controls power of the output microwaves based on the difference signal. For example, when the microwave generator 110 generates and outputs a plurality of microwaves, the controller 310 compares power of each of a plurality of microwaves and reference power and constantly controls output power of the plurality of microwaves based on a difference signal.

Further, the controller 310 calculates a heating efficiency of each of a plurality of microwaves based on microwaves reflected from the inside of a cavity in microwaves output by the microwave generator 110.

$${h}_{e} = \frac{{p}_{t} - {p}_{r}}{{p}_{t}} \qquad [ Equation 1 ]$$

Here, Pₜ represents power of microwaves emitted into the cavity 134, Pr represents power of microwaves reflected from the cavity 134, and he represents a heating efficiency of microwaves.

According to Equation 1, as power of reflected microwaves increases, the heating efficiency he decreases.

A calculation of such a heating efficiency may be performed at an entire cooking segment. Particularly, when the entire cooking segment includes a scan segment and a heating segment, a calculation of a heating efficiency may be performed at a scan segment.

FIG. 4 illustrates that a plurality of microwaves having a sequentially increasing frequency at a scan segment Ts are emitted into the cavity 134. Accordingly, a calculation of a heating efficiency may be performed for a scan segment Ts.

The scan segment may be performed before a heating segment of an entire cooking segment, but an order of the scan segment is not limited thereto and the scan segment may be performed simultaneously with a heating segment. That is, scanning and heating can be simultaneously performed on a frequency basis.

The controller 310 controls to vary an output period on a frequency basis or a power level on a frequency basis of a plurality of microwaves emitted into the cavity 134 at a heating segment according to a heating efficiency calculated on a frequency basis. That is, the controller 310 outputs a phase control signal for varying an output period on a frequency basis or a power level on a frequency basis to an amplifier (not shown) within the microwave generator 110.

For example, when a heating efficiency he calculated at a predetermined frequency is high, the controller 310 may control to reduce an output period or an output power level of corresponding microwaves. Further, when a heating efficiency he calculated at a predetermined frequency is low, the controller 310 may control to increase an output period or an output power level of corresponding microwaves.

That is, while a plurality of microwaves are sequentially swept, the controller 310 varies an output period or an output power level of each microwave according to a calculated heating efficiency.

Accordingly, the controller 310 controls to uniformly absorb microwaves on a frequency basis to a heating target 140 within the cavity 134, thereby uniformly heating the heating target 140.

Only when a heating efficiency he calculated on a frequency basis is a setting value or more, the controller 310 may control to output microwaves of a corresponding frequency. That is, by excluding microwaves of a frequency having a remarkably low heating efficiency he at an actual heating segment, the heating target 140 can be efficiently and uniformly heated.

The amplifier (not shown) and the directional coupler 338 within the microwave generator 110 may be formed as one module. That is, the amplifier and the directional coupler 338 may be disposed on one substrate to be formed as one module.

The controller 310 controls to display an operation state of the cooking appliance through the display unit 105. For example, at an entire cooking segment, when a present segment is a scan segment, the present segment may be displayed through the display unit 105, and when a present segment is an actual heating segment, the present segment may be displayed through the display unit 105. Further, a display function of various forms such as a display of a remained time of the entire cooking segment may be performed.

The power supply unit 114 boosts a voltage of power input to the cooking device 100 to a high voltage and outputs the power to the microwave generator 110. The power supply unit 114 may be embodied as a high voltage transformer or an inverter.

FIG. 5 is a block diagram illustrating an example of the inside of the microwave generator of FIG. 3.

Referring to the drawing, a microwave generator 510 of FIG. 5 includes an amplifier 530, a phase shifter 540, and a circulator 550.

The amplifier 530 receives DC power from the power supply unit 114 and performs frequency oscillation and amplification. That is, the amplifier 530 voluntarily performs frequency oscillation and amplification operation according to an input of DC power without a separate frequency oscillator for generating and outputting a frequency oscillation signal.

The amplifier 530 may include at least one RF power transistor, and when the amplifier 530 uses a plurality of RF power transistors, the amplifier 530 may perform multistage amplification in series, parallel, or a mixed method of series and parallel. The amplifier 530 may be, for example, an RF power transistor. An output of the amplifier 530 may be approximately 100 to 1000 W.

Next, the phase shifter 540 shifts a phase by feedback of an output of the amplifier 530. A phase shift amount can be adjusted according to a phase control signal of the controller 310. By shifting a phase of an amplification signal of a predetermined frequency output from the amplifier in this way, microwaves of various frequencies may be generated, as described above. For example, a frequency may increase in proportional to a phase shift amount.

It is preferable that a signal corresponding to approximately 1 to 2% of an amplification signal level of a predetermined frequency is sampled and is input to the phase shifter 540. This is performed in consideration of re-amplification in the amplifier 530 after feedback.

Next, the circulator 550 supplies again a signal in which a phase is shifted in the phase shifter 540 to the amplifier 530. When a level of a signal in which a phase is shifted in the phase shifter 540 is less than a setting value, the circulator 550 may supply the signal in which a phase is shifted to a ground terminal instead of the amplifier 530.

The signal supplied from the circulator 550 is amplified again in the amplifier 530. Accordingly, a plurality of microwaves having different frequencies are sequentially output.

In this way, because the amplifier 530 voluntarily performs frequency oscillation and amplification, the microwave generator 510 can be simply embodied. Further, by using the phase shifter 540, a plurality of microwaves can be generated and output.

FIG. 6 is a block diagram illustrating another example of the inside of the microwave generator of FIG. 3.

Referring to the drawing, a microwave generator 610 of FIG. 6 is almost the same as the microwave generator 510 of FIG. 5, and the microwave generator 610 is different from the microwave generator 510 in that at least one amplifier is further provided in an output terminal of an amplifier 630.

In the drawing, a plurality of amplifiers 660-1, . . . , 660-n are connected in parallel, but are not limited thereto and may be formed for multistage amplification in series or a mixed method of series and parallel. The plurality of amplifiers 660-1, . . . , 660-n may be, for example, an RF power transistor.

As shown in FIG. 6, as the plurality of amplifiers 660-1, ? 660-n are formed, a high output of microwaves can be simply generated using the plurality of amplifiers 630, 660-1, . . . , 660-n.

The microwave generators 510 and 610 described with reference to FIGS. 5 and 6 may be formodied as a solid state power module (SSPM).

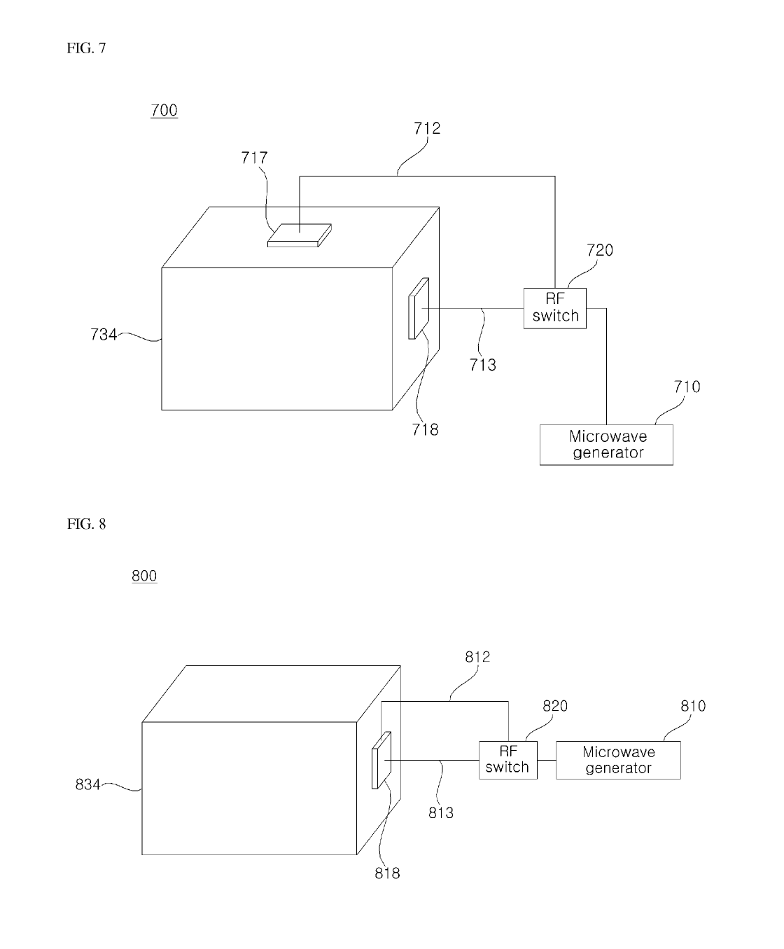

FIG. 7 is a block diagram illustrating another example of a cooking appliance according to an exemplary embodiment of the present invention.

Referring to the drawing, a cooking appliance 700 of FIG. 7 includes a microwave generator 710, an RF switch 720, a plurality of microwave transmitting units 712 and 713, and a plurality of feeders 717 and 718.

The microwave generator 710 may generate and output a plurality of microwaves of different frequencies. Such a plurality of microwaves may be sequentially generated and output, as described above.

As described above, the microwave generator 710 may include an amplifier that can voluntarily perform oscillation and amplification. That is, when DC power is supplied from a power source unit, the microwave generator 710 can voluntarily perform oscillation and amplification without a separate frequency oscillator. Further, as described above, the microwave generator 710 may further include a phase shifter and a circulator.

The RF switch 720 separates a transfer path of microwaves in plural. In the drawing, the RF switch 720 is connected to each of first and second microwave transmitting units 712 and 713, but it is not limited thereto and the RF switches of various numbers may be separated in various paths. The first and second microwave transmitting units 712 and 713 may include a waveguide or a coaxial cable. The feeders 717 and 718 are connected to end portions of the first and second microwave transmitting units 712 and 713, respectively.

The feeders 717 and 718 output microwaves transmitted into a cavity 734. For this reason, the feeders 717 and 718 may include an opening or an antenna. Further, the feeders 717 and 718 may further include an amplifier. As the feeders 717 and 718 include an amplifier, an output level of microwaves generated in and output from the microwave generator 710 can be further improved. In this case, an amplification rate of the amplifier within each of the feeders 717 and 718 may be different.

The RF switch 720 may separate a transfer path of microwaves according to a scan segment and a heating segment.

For example, at a scan segment in which a high output is unnecessary, a low output of microwaves are supplied into the cavity 734 through the first microwave transmitting unit 712 and the first feeder 717, and at a heating segment in which a high output is necessary, a high output of microwaves can be supplied into the cavity 734 through the second microwave transmitting unit 713 and the second feeder 718. An output difference between the scan segment and the heating segment may be changed according to an amplification rate of an amplifier provided in each of the feeders 717 and 718. That is, an amplification rate of an amplifier of the first feeder 717 may be lower than that of an amplifier of the second feeder 718.

FIG. 8 is a block diagram illustrating another example of a cooking appliance according to an exemplary embodiment of the present invention.

Referring to the drawing, a cooking appliance 800 of FIG. 8 is almost similar to the cooking appliance 700 of FIG. 7, but the cooking appliance 800 is different from the cooking appliance 700 in the number of feeders and the number of microwave transmitting units according to the number of feeders.

Due to the difference, a microwave generator 810 generates and outputs a plurality of microwaves of different frequencies, and an RF switch 820 separates a transfer path of microwaves in plural. In the drawing, first and second microwave transmitting units 812 and 813 are each connected.

One feeder 818 is connected to an end portion of the first and second microwave transmitting units 812 and 813. A feeder 818 may include an opening or an antenna. Further, the feeder 818 may further include an amplifier.

Transfer paths may be each distinguished at a scan segment and a heating segment of an entire cooking segment. For example, at a scan segment in which a high output is unnecessary, a low output of microwaves may be supplied into a cavity 834 through the first microwave transmitting unit 812 and the feeder 818, and at a heating segment in which a high output is necessary, a high output of microwaves may be supplied into the cavity 834 through the second microwave transmitting unit 813 and a feeder 18.

In this case, in order to differently make an output of a scan segment and a heating segment, an amplifier provided at the inside is not used at a scan segment, microwaves are directly output into the cavity 834 through an opening or an antenna. At a heating segment, microwaves amplified in a high output are output into the cavity 834 through an opening or an antenna using an amplifier provided at the inside.

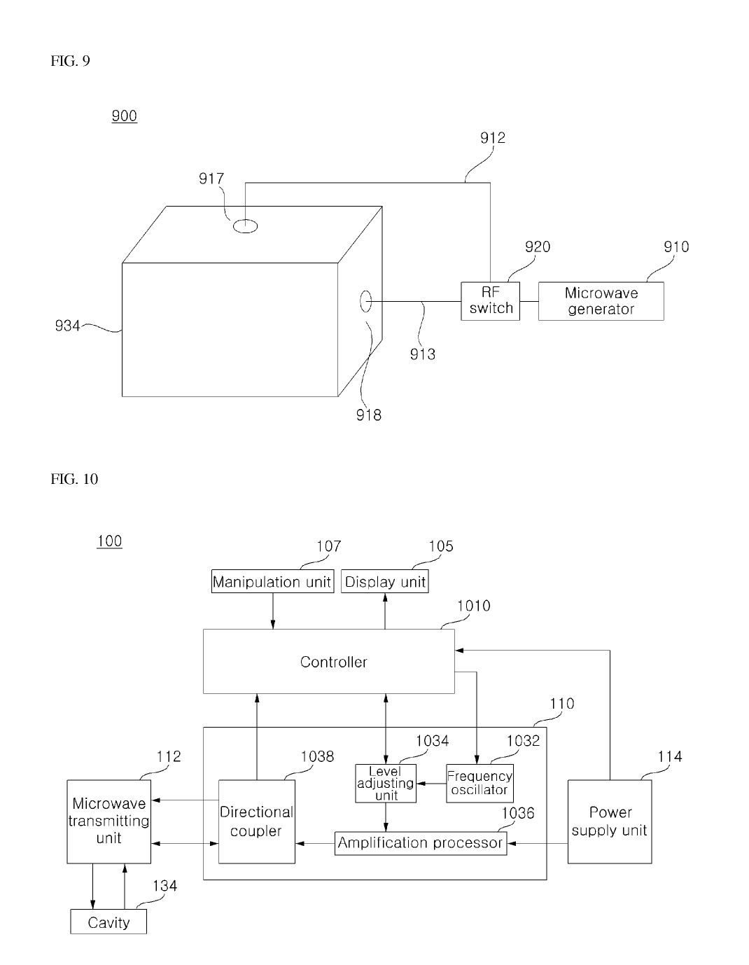

FIG. 9 is a block diagram illustrating another example of a cooking appliance according to an exemplary embodiment of the present invention.

Referring to the drawing, a cooking appliance 900 of FIG. 9 is almost similar to the cooking appliance 700 of FIG. 7, but the cooking appliance 900 is different from the cooking appliance 700 in that an opening or an antenna as feeders 917 and 918 is connected without a separate amplifier to an end portion of first and second microwave transmitting units 912 and 913. However, an RF switch 912 may include an amplifier. In this case, the amplifier may be separately used at a scan segment and a heating segment. That is, the amplifier may not be used at a scan segment and may be used at a heating segment. Thereby, an output level difference may exist between a scan segment and a heating segment.

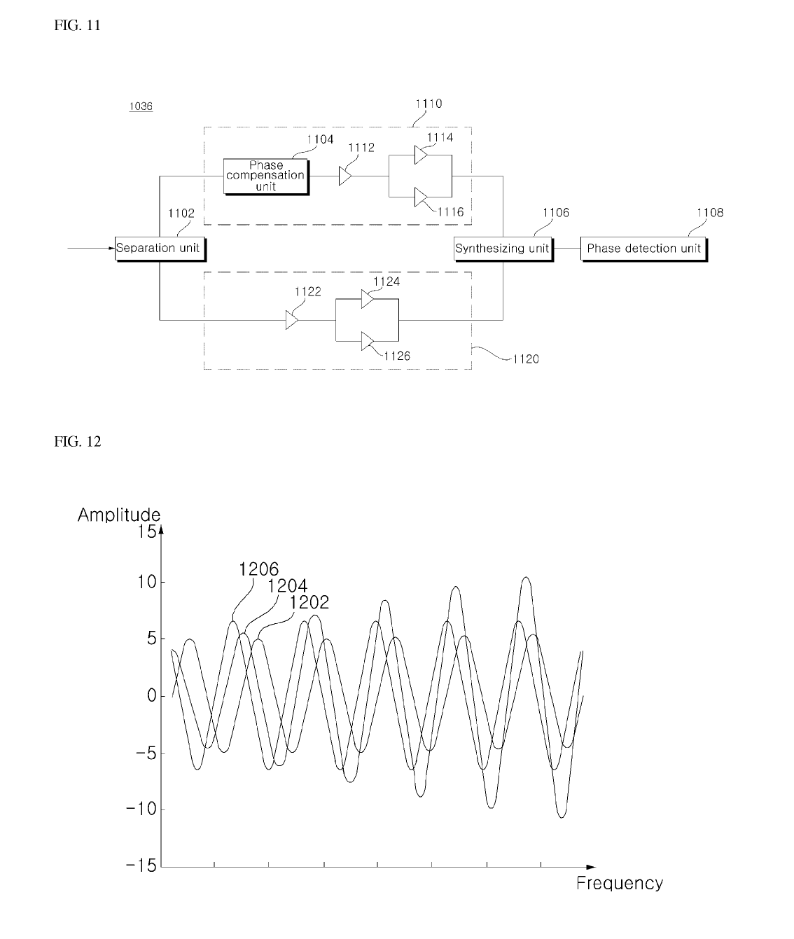

FIG. 10 is another example illustrating a block diagram of the cooking appliance of FIG. 1.

Referring to the drawing, the cooking appliance 100 according to an exemplary embodiment of the present invention includes a microwave generator 110 and a controller 1010. Further, the cooking appliance 100 may further include a microwave transmitting unit 112.

The microwave generator 110 includes a frequency oscillator 1032, a level adjusting unit 1034, and an amplification processor 1036. Further, the microwave generator 110 may further include a directional coupler 1038.

The frequency oscillator 1032 oscillates to output microwaves of a corresponding frequency by a frequency control signal from the controller 1010. The frequency oscillator 1022 may include a voltage controlled oscillator (VCO). The VCO oscillates a corresponding frequency according to a voltage level of a frequency control signal. For example, as a voltage level of a frequency control signal increases, a frequency oscillated and generated in the VCO becomes large.

The level adjusting unit 1034 enables to output microwaves with corresponding power by a power control signal from the controller 1010. The level adjusting unit 1034 may include a voltage controlled attenuator (VCA). The VCA performs a correction operation to output microwaves with corresponding power according to a voltage level of a power control signal. For example, as a voltage level of a power control signal increases, a power level of a signal output from the VCA increases.

The level adjusting unit 1034 receives the same power control signal from the controller 1010 for each microwave for a heating segment, thereby constantly outputting power intensity of each of a plurality of microwaves.

Further, because power intensity is constant for a heating segment using microwaves, the level adjusting unit 1034 for controlling power may not be separately provided.

The amplification processor 1036 performs an amplification operation to output with a preset frequency and power via the frequency oscillator 1032 and the level adjusting unit 1034. As described above, the amplification processor 1036 may include an SSPA using a semiconductor element, particularly, may include monolithic microwave integrated circuits (MMIC) using a single substrate. Thereby, the amplification processor 1036 can easily be controlled by the controller 1010 and can integrate an element due to a small size.

Further, the amplification processor 1036 according to the present invention may include a plurality of amplification stages for amplifying each of a plurality of microwaves having the same frequency and connected in parallel, a phase detection unit for detecting phase deformation of each microwave having the same frequency, and a phase compensation unit for compensating phase deformation of microwaves having a deformed phase when a phase of at least one of a plurality of microwaves is deformed. Here, each amplification stage for amplifying each of a plurality of microwaves may include a solid state power amplifier (SSPA) using a semiconductor.

Further, the amplification processor 1036 may further include a separation unit for separating one microwave oscillated by a single oscillation signal into a plurality of microwaves at the front end of the amplification stage.

In this case, the phase detection unit detects phase deformation of microwaves by sensing an amplitude of added microwaves by each of microwaves amplified by each amplification stage. Further, the phase detection unit detects phase deformation of microwaves by sensing a frequency of each microwave.

Further, the amplification processor 1036 may further include an adder for adding each of microwaves amplified by each amplification stage, and the phase detection unit may be provided at the rear end of the adder.

The phase compensation unit compensates a phase of microwaves having a deformed phase using a phase shifter. Further, the phase compensation unit compensates a phase by equally adjusting an upper amplification length and a lower amplification length of microwaves having a deformed phase. In this case, the phase compensation unit may be provided at the front end or the rear end of an amplification stage.

The directional coupler (DC) 1038 transfers microwaves amplified in and output from the amplification processor 1036 to the microwave transmitting unit 112. Microwaves output from the microwave transmitting unit 112 heat a target within the cavity 134. Microwaves reflected instead of being absorbed into the subject are again input to the directional coupler 1038 through the microwave transmitting unit 112. The directional coupler 1038 transfers the reflected microwaves to the controller 1010.

The microwave generator 110 may further include a DC converter (not shown) disposed between the directional coupler 1038 and the controller 1010 and for converting the reflected microwaves to a control signal. Here, the DC converter (not shown) may be formed as a diode element.

The microwave generator 110 may further include an isolation unit (not shown) disposed between the amplification processor 1036 and the directional coupler 1038 and for passing microwaves when transferring microwaves amplified in the amplification processor 1036 to the cavity 134 and for blocking microwaves reflected from the cavity 134. Here, the isolation unit (not shown) may be formed as an isolator.

The frequency oscillator 1032, the level adjusting unit 1034, and the amplification processor 1036, and the directional coupler 1038 within the microwave generator 110 may be formed as one module. That is, the frequency oscillator 1032, the level adjusting unit 1034, and the amplification processor 1036, and the directional coupler 1038 may be disposed on a single substrate and formed as one module. By integration of an element, the microwave generator 110 can be easily controlled by the controller 1010.

The controller 1010 controls general operations of the cooking appliance. When an operation signal of the cooking appliance is input through the manipulation unit 107, the controller 1010 controls the microwave generator 110 to output microwaves.

Further, the controller 1010 calculates a heating efficiency of each of a plurality of microwaves based on microwaves reflected from the inside of the cavity in microwaves output by the microwave generator 110 and sets a heating time of each microwave for a heating segment according to the calculated heating efficiency.

Specifically, the controller 1010 controls the frequency oscillator 1032 to oscillate a corresponding frequency by outputting a frequency control signal.

In order to output microwaves having a plurality of frequencies, the controller 1010 controls to output a frequency control signal of different voltage levels. Accordingly, the frequency oscillator 1032 oscillates a corresponding frequency according to a voltage level of the input frequency control signal. Such a plurality of frequency control signals may be sequentially output from the controller 1010.

The controller 1010 controls the level adjusting unit 1034 to output a corresponding power level by outputting a power control signal.

In this case, the controller 1010 controls to output the same power control signal for each microwave to the microwave generator for a heating segment. Further, the level adjusting unit 1034 outputs a predetermined power level according to the input power control signal.

The controller 1010 calculates a heating efficiency based on microwaves reflected instead of being absorbed into a target in microwaves emitted into the cavity 134. A heating efficiency is calculated with reference to Equation 1.

When a plurality of microwaves are emitted into the cavity 134, the controller 1010 calculates a heating efficiency he on a frequency basis of a plurality of microwaves. It is preferable that a calculation of such a heating efficiency is performed at a scan segment among a scan segment and a heating segment of an entire cooking segment.

At the entire cooking segment, the heating segment may be performed after the scan segment and the heating segment may be performed while performing the scan segment. Further, the entire cooking segment may be repeatedly performed.

That is, the controller 1010 calculates a heating efficiency he on a frequency basis through reflected microwaves by sequentially emitting a plurality of microwaves to the heating target 140 within the cavity 134 at a cooking segment in which a user sets.

Only when a heating efficiency he calculated on a frequency basis is a setting value or more, the controller 1010 controls to emit microwaves of a corresponding frequency at a heating segment. That is, by excluding microwaves of a frequency having a remarkably low heating efficiency he at an actual heating segment, the controller 1010 can heat efficiently and uniformly heat the heating target 140.

Emission of a plurality of microwaves can be sequentially performed.

The controller 1010 controls to display an operation state of the cooking appliance through the display unit 105. For example, at an entire cooking segment, when a present segment is a scan segment, the controller 1010 controls to display the present segment through the display unit 105, and when a present segment is an actual heating segment, the controller 1010 controls to display the present segment. Further, the display unit 105 performs a display function of various forms such as display of the remaining time of an entire cooking segment.

The power supply unit 114 boosts a voltage of power input to the cooking appliance 100 to a high voltage and outputs the power to the microwave generator 110. The power supply unit 114 may be formed in a high voltage transformer or an inverter. The power supply unit 114 may generate and supply a predetermined control power source for a control operation of a controller (not shown).

The controller 1010 and the microwave generator 110 may be formed in one module. That is, the controller 1010 and the microwave generator 110 can be integrated on a single substrate.

A method of controlling a cooking appliance using microwaves according to the present invention will be described with reference to the configuration.

The controller 1010 outputs a frequency control signal for sweeping microwaves of various frequencies for a scan segment to the frequency oscillator 1032 of the microwave generator 110.

The frequency oscillator 1032 generates a plurality of microwaves according to a frequency control signal that is input from the controller 1010.

The level adjusting unit 1034 adjusts a level corresponding to an amplitude of microwaves generated by the frequency oscillator 1032 according to a power control signal that is input from the controller 1010. In this case, a power control signal in which the controller 500 outputs to the level adjusting unit 1034 may be provided as the same signal for all microwaves using in a sweep process.

The amplification processor 1036 amplifies microwaves having an adjusted level, an isolation unit (not shown) provides the amplified microwaves to the directional coupler 520, the directional coupler 1038 provides microwaves provided by the isolation unit (not shown) to the microwave transmitting unit 112.

The microwave transmitting unit 112 outputs microwaves provided by the directional coupler 520 to the cavity 134.

When some of microwaves output from the cavity 134 are reflected, the directional coupler 1038 provides the reflected microwaves to a DC converter (not shown).

The DC converter (not shown) outputs a feedback signal that converts some of microwaves reflected from the cavity 134 to DC to the controller 1010.

The controller 1010 calculates a heating efficiency of each of a plurality of microwaves based on the input feedback signal. In this case, when a feedback signal of each microwave is small, the controller 1010 determines that the microwave has a high heating efficiency.

Further, the controller 1010 controls to vary an emission time of each microwave for a heating time, i.e., a heating segment of each microwave according to a heating efficiency of each of the calculated microwaves.

The frequency oscillator 1032 generates a corresponding microwave according to a frequency control signal provided from the controller 1010.

The level adjusting unit 1034 adjusts a level corresponding to an amplitude of microwaves generated by the frequency oscillator 1032 according to a power control signal provided from the controller 1010. In this case, a power control signal in which the controller 1010 provides to the level adjusting unit 1034 may be provided as the same signal for all microwaves using at a heating segment.

The amplification processor 1036 amplifies microwaves having an adjusted level, an isolation unit (not shown) provides the amplified microwaves to the directional coupler 1038, the directional coupler 1038 provides microwaves provided by the isolation unit (not shown) to the microwave transmitting unit 112, and the microwave transmitting unit 112 outputs microwaves provided by the directional coupler 1038 to the cavity 134.

In this case, the amplification processor 1036 includes a plurality of amplification stages for amplifying each of a plurality of microwaves having the same frequency and connected in parallel, a phase detection unit for detecting phase deformation of each microwave having the same frequency, and a phase compensation unit for compensating phase deformation of microwaves having a deformed phase when a phase of at least one of a plurality of microwaves is deformed.

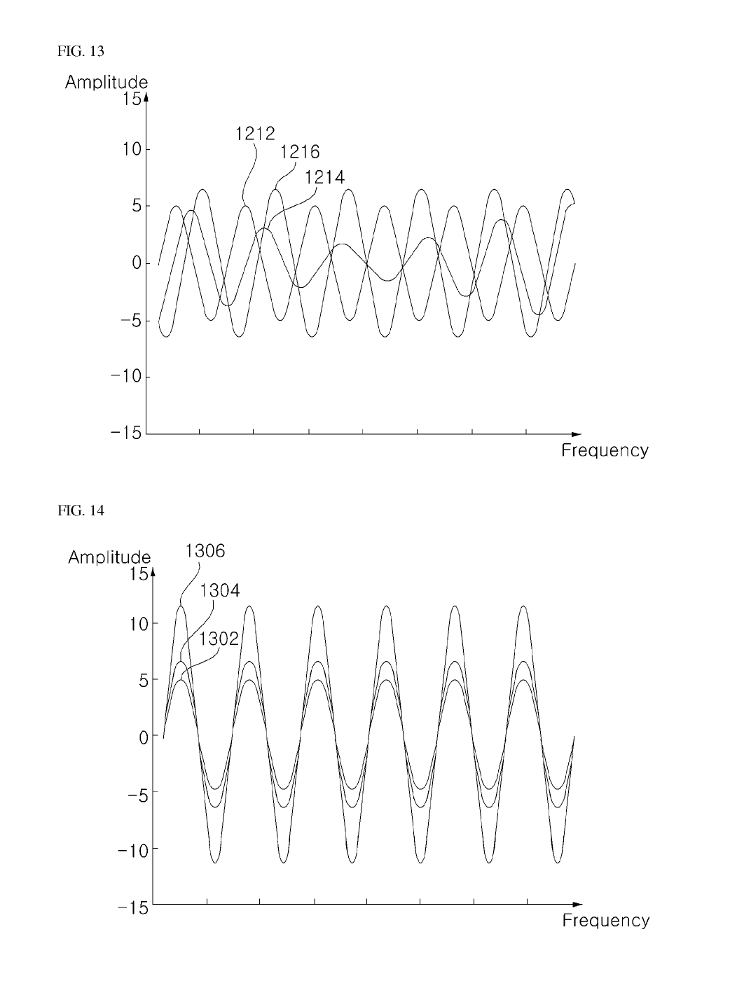

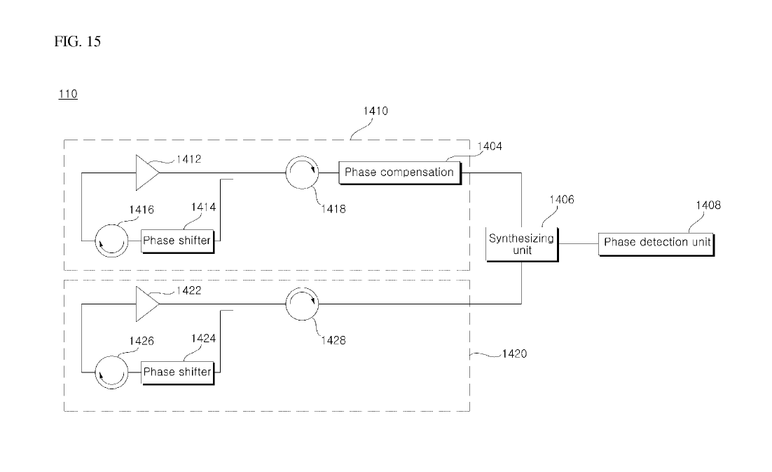

FIG. 11 is a diagram illustrating a configuration of the amplification processor of FIG. 10, FIGS. 12 and 13 are graphs illustrating various examples of added microwave and microwave amplified at each amplification stage of FIG. 11, and FIG. 14 is a graph illustrating microwaves in which a deformed phase is compensated according to FIG. 11.

Referring to the drawings, an amplification processor according to an exemplary embodiment of the present invention includes a first amplification stage 1110 including a separation unit 1102 and at least one amplifiers 1112, 414, and 416 and a second amplification stage 1120 including at least one amplifiers 1122, 424, and 426 and connected parallel to the first amplification stage, a synthesizing unit 1106, a phase detection unit 1108, and a phase compensation unit 1104. In this case, as shown in FIG. 4, the phase compensation unit 1104 is included in the first amplification stage to be provided at the front end of at least one amplifier 1112, 414, and 416.

First, the separation unit 1102 receives an input of one microwave oscillated by an oscillation signal and separates the input one microwave into a plurality of microwaves. In this case, the oscillation signal may be a signal that is input via the frequency oscillator 1032 having a voltage controlled oscillator (VCO) of FIG. 10 and the level adjusting unit 1034 having a voltage controlled attenuator (VCA).

The first amplification stage 1110 and the second amplification stage 1120 are provided in a parallel form to amplify each of a plurality of microwaves having the same frequency.

The synthesizing unit 1106 adds each of microwaves amplified by each of the amplification stages 1110 and 420.

The phase detection unit 1108 detects phase deformation of each microwave having the same frequency.

In this case, for example, the phase detection unit 1108 detects phase deformation of microwaves by sensing an amplitude of a microwave 1206 added by each of microwaves 1202 and 1204 amplified by each amplification stage shown in FIG. 12.

Further, the phase detection unit 1108 detects phase deformation of microwaves by sensing a frequency of microwaves 1212 and 1214 amplified at each amplification stage shown in FIG. 13.

Here, when deformation of a phase of at least one of a plurality of microwaves is detected, the phase compensation unit 1104 compensates phase deformation of microwaves having a deformed phase.

In this case, the phase compensation unit 1104 compensates a phase of microwaves having a deformed phase using a phase shifter. Further, the phase compensation unit compensates a phase by equally adjusting an upper amplification length and a lower amplification length of microwaves having a deformed phase. Further, the phase compensation unit 1104 may be provided at the front end or the rear end of some of a plurality of amplification stages. Accordingly, even if phase deformation, i.e., phase deviation of microwaves occurs at each amplification stage, the phase compensation unit 1104 can compensate the phase deformation, as shown in FIG. 14.

FIG. 14 illustrates a first microwave 1302 amplified by a first amplification stage due to compensation of phase deformation when phase deformation is detected, a second microwave 1304 amplified by a second amplification stage, and a microwave 1306 in which the first microwave and the second microwave are added.

Operation of the phase compensation unit 1104 may be controlled by an output of the phase detection unit 1108, or by a control signal from the controller 1010 according to a signal detected from the phase detection unit 1108.

FIG. 15 is a block diagram illustrating another example of the inside of the microwave generator of FIG. 3.

Referring to the drawing, the microwave generator 110 according to another exemplary embodiment of the present invention includes a first amplification stage 1410 including an amplifier 1412, a phase shifter 1414, a first circulator 1416, a second circulator 1418, a second amplification stage 1420 including an amplifier 1422, a phase shifter 1424, a first circulator 1426, and a second circulator 1428, a phase compensation unit 1404, a synthesizing unit 1406, and a phase detector 1408.

In this case, as shown in FIG. 15, the phase compensation unit 1404 may be included in the first amplification stage 1410.

The first amplification stage 1410 and the second amplification stage 1420 are provided in a parallel form to amplify each of a plurality of microwaves having the same frequency.

The synthesizing unit 1406 adds each of microwaves amplified by each of the amplification stages 1410 and 1420.

The phase detection unit 1408 detects phase deformation of each microwave having the same frequency.

In this case, for example, the phase detection unit 1408 may detect phase deformation of microwaves by sensing amplitude of a microwave 1106 added by each of microwaves 1202 and 1204 amplified by each amplification stage shown in FIG. 12.

Further, the phase detection unit 1408 detects phase deformation of microwaves by sensing a frequency of microwaves 1212 and 1214 amplified at each amplification stage shown in FIG. 13.

Here, when phase deformation of at least one of a plurality of microwaves is detected, the phase compensation unit 1404 compensates phase deformation of microwaves having a deformed phase.

In this case, the phase compensation unit 1404 compensates a phase of microwaves having a deformed phase using a phase shifter. Further, the phase compensation unit compensates a phase by equally adjusting an upper amplification length and a lower amplification length of microwaves having a deformed phase. Accordingly, even if phase deformation, i.e., phase deviation of microwaves occurs at each amplification stage, the phase compensation unit 1404 compensates the phase deformation, as shown in FIG. 14.

It will be understood by those skilled in the art that various changes in form and details may be made therein without departing from the spirit and scope of the invention. Therefore, the scope of the invention is defined not by the detailed description of the invention but by the appended claims, and all differences within the scope will be construed as being included in the present invention. This invention is to be understood that the invention is not limited to the disclosed embodiments, but, on the contrary, is intended to cover various modifications and equivalent arrangements included within the spirit and scope of the appended claims.

1. A cooking appliance using microwaves, comprising:
a microwave generator comprising an amplifier for performing frequency oscillation and amplification and for generating and outputting microwaves; and
a feeder for outputting the output microwaves to the inside of a cavity.

2. The cooking appliance of claim 1, wherein the microwave generator further comprises a phase shifter for shifting a phase of the output microwaves and a circulator for supplying microwaves having a shifted phase to the amplifier,
wherein the microwave generator generates and outputs a plurality of microwaves of different frequencies according to the shifted phase.

3. The cooking appliance of claim 1, further comprising a controller for supplying a phase shift signal to the microwave generator,
wherein the microwave generator generates and outputs a plurality of microwaves having a varying frequency according to the phase shift signal.

4. The cooking appliance of claim 3, wherein the controller controls to calculate a heating efficiency on a frequency basis using microwaves supplied into the cavity and microwaves reflected from the cavity and to vary an output period or a power level of a plurality of microwaves generated in the microwave generator at a heating segment according to the calculated heating efficiency.

5. The cooking appliance of claim 1, wherein the microwave generator further comprises at least one amplifier connected to an output terminal of the amplifier in at least one of series and parallel.

6. The cooking appliance of claim 1, further comprising an RF switch for separating a transmission path of microwaves from the microwave generator.

7. The cooking appliance of claim 6, further comprising a plurality of microwave transmitting units for transmitting microwaves separated by the RF switch to a plurality of feeders, respectively.

8. The cooking appliance of claim 6, wherein the RF switch separates a transmission path of the microwaves according to a scan segment and a heating segment at an entire cooking segment.

9. The cooking appliance of claim 6, wherein the feeder is provided in plural according to a scan segment and a heating segment of the entire cooking segment, and a feeder for the heating segment comprises an amplifier.

10. The cooking appliance of claim 7, wherein the feeder comprises an amplifier,
wherein microwaves input to the feeder at a scan segment of an entire cooking segment are emitted to the cavity, and
microwaves input to the feeder at a scan segment of the entire cooking segment are amplified in the amplifier and are emitted to the cavity.

11. A cooking appliance using microwaves, comprising:
a microwave generator for generating and outputting a plurality of microwaves;
an RF switch for separating a transmission path of the microwaves; and
a feeder for outputting microwaves output from the RF switch to the inside of a cavity.

12. The cooking appliance of claim 11, further comprising a plurality of microwave transmitting units for transmitting each of microwaves separated by the RF switch to a plurality of feeders.

13. The cooking appliance of claim 11, wherein the RF switch separates a transmission path of the microwaves according to a scan segment and a heating segment of an entire cooking segment.

14. The cooking appliance of claim 11, wherein the feeder is provided in plural according to a scan segment and a heating segment of the entire cooking segment, and a feeder for the heating segment comprises an amplifier.

15. The cooking appliance of claim 11, wherein the feeder comprises an amplifier,
wherein microwaves input to the feeder at a scan segment of an entire cooking segment are emitted to the cavity, and
microwaves input to the feeder at a scan segment of the entire cooking segment are amplified in the amplifier and are emitted to the cavity.

16. The cooking appliance of claim 11, wherein the RF switch comprises an amplifier,
wherein microwaves input to the RF switch at a heating segment of an entire cooking segment are amplified in the amplifier and are transmitted to the feeder.

17. A cooking appliance using microwaves, comprising:
a plurality of amplification stages for amplifying a plurality of microwaves, respectively;
a phase detection unit for detecting phase deformation of each microwave having the same frequency; and
a phase compensation unit for compensating phase deformation of microwaves having a deformed phase when a phase of at least one of the plurality of microwaves is deformed.

18. The cooking appliance of claim 17, further comprising a separation unit for separating one microwave into a plurality of microwaves at the front end of the amplifier stage.

19. The cooking appliance of claim 17, further comprising an adder for adding each of microwaves amplified by each amplification stage included in the amplification unit.

20. The cooking appliance of claim 17, wherein the phase detection unit detects phase deformation of microwaves by sensing an amplitude of microwaves in which microwaves amplified by the each amplification stage are added or detects phase deformation of microwaves by sensing a frequency of the each microwave.
